(19) United States
(12) Patent Application Publication
(10) Pub. No.: US 2026/0302857 A1
(43) Pub. Date: Oct. 1, 2026

(54) ROTOR AND METHOD FOR MANUFACTURING A ROTOR FOR AN EXTERNAL ROTOR MOTOR

(71) Applicant: BorgWarner Inc., Auburn Hills, MI (US)

(72) Inventors: Silvio Koch, Kirchheimbolanden (DE); Daniel Knopp, Bad Kreuznach (DE); Amir Rohi, Birkenau (DE); Nuno Miguel Ribeiro de Sousa Sarafana, Almada (PT)

(21) Appl. No.: 19/629,264

(22) Filed: Mar. 26, 2026

(30) Foreign Application Priority Data
Apr. 1, 2025 (DE) 102025001117.2

(51) Int. Cl. H02K 1/28; H02K 1/2791; H02K 15/0278; H02K 15/035

(52) U.S. Cl. CPC H02K 1/28; H02K 1/2791; H02K 15/0278; H02K 15/035

(57) ABSTRACT

A rotor for an external rotor motor, including an annular stack of steel sheets welded together, permanent magnets attached to an inner side of the stack, and a carrier into which the stack is inserted. A gap between an outer surface of the stack and an inner surface of the carrier contains a filling material. In addition, a method for manufacturing such a rotor is disclosed.

### CROSS REFERENCE TO RELATED APPLICATIONS

This application claims priority to DE 10 2025 001 117.2 filed on Apr. 1, 2025, the disclosure of which is hereby incorporated herein by reference.

### BACKGROUND

The present disclosure relates to a rotor for an external rotor motor, comprising an annular stack of steel sheets, permanent magnets attached to an inner side of the stack, and a carrier into which the stack is inserted.

An example of a rotor is disclosed in DE 10 2023 119 408 A1.

A problem with such rotors is that even a small imbalance may cause relative movements between the carrier and the stack, which can lead to disturbing noise, in particular rattling. To remedy this problem, strict manufacturing tolerances are usually specified and the rotor is carefully balanced, for example by removing material at specified locations.

### SUMMARY

The present disclosure shows a way in which a rotor for an external rotor motor can be manufactured with less effort and can be operated without generating disturbing noise.

This task is solved by a rotor with the features described herein and by a method described herein. Advantageous refinements are also described herein.

In a rotor according to the present disclosure, a gap between an outer side of the stack and an inner side of the carrier is filled with a filling material, for example adhesive. The considerable effort required with conventional rotors to avoid such a gap or relative movement between the stack and the carrier is no longer necessary with such a rotor, since the filling material largely prevents relative movements between the sheet and the carrier and the associated noise, in particular rattling.

The filling material may be poured in, for example, through a radially extending opening, such as a continuous bore, in the carrier after the stack has been inserted into the carrier. Preferably, the carrier has several filling openings. The filling openings can be arranged in a circumferential direction.

An advantageous refinement provides that the opening widens towards the outside of the carrier. For example, the opening may have a conical section that widens towards the outside of the carrier. This conical section may be followed by a cylindrical section that leads to the gap. This facilitates the pouring of the filling material.

Another advantageous refinement is that the carrier has a notch in an axial end face, said notch running from an inside to an outside of the carrier. Such a notch makes it easier to control the pouring of filling material, for example by visually monitoring the notch. As soon as filling material from the gap enters the notch between the sheet metal stack and the carrier, it can be assumed that the gap has been sufficiently filled and the pouring of filling material can therefore be stopped. The distance between the edge of the carrier and the filling opening may be minimal in the notch. As a rule, during filling process filling material spreads evenly in all directions in the gap between the stack and the carrier; in other words, the filling material forms an approximately circular disc between the sheet metal stack and the carrier. This then causes the filling material to first exit the notch from the gap between the stack and the carrier. A small notch is sufficient for monitoring the pouring of filler material, for example a notch whose depth is no more than twice the width of the filling opening. The notch should preferably be narrow so that the pouring of filling material can be stopped as soon as a small amount of filling material enters the notch. For example, a notch with a width no more than twice the width of the filling opening is sufficient. The width of the notch is to be measured in the circumferential direction of the carrier.

A further advantageous refinement provides that the carrier has slots running in the axial direction of the rotor. Clamps that press the stack against the carrier in the axial direction may be arranged in these slots. If adhesive is used as the filling material, the filling material can support or even replace the mechanical connection between the carrier and the stack. However, especially in the case of high mechanical loads, clamps generally enable a more reliable fastening of the sheet stack to the carrier.

A further advantageous refinement provides that the slots are open at their distal end, i.e., the end facing away from the hub of the rotor. Preferably, the slots widen toward their distal end. For example, the slots may have a funnel-shaped end section. This facilitates the insertion of the sheet stack into the carrier.

### BRIEF DESCRIPTION OF THE DRAWINGS

Further details and advantages of the invention are explained in an embodiment of the invention with reference to the accompanying drawings.

FIG. 1 is an embodiment of an exemplary rotor;

FIG. 2 is a further view of the rotor;

FIG. 3 shows a detail of a sectional view of the rotor;

FIG. 4 is a detailed view of FIG. 2; and

FIG. 5 is a detailed view of the rotor carrier, viewed from the inside.

Corresponding reference characters indicate corresponding parts throughout the several views. Although the exemplification set out herein illustrates an embodiment of the invention, in one form, the embodiment disclosed below is not intended to be exhaustive or to be construed as limiting the scope of the invention to the precise form disclosed.

### DETAILED DESCRIPTION

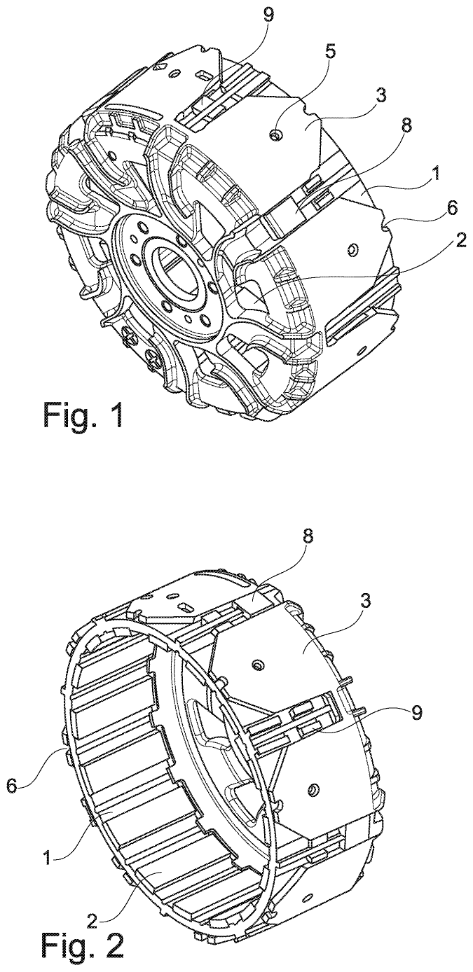

FIGS. 1 and 2 show a rotor of an electric motor, more specifically an external rotor motor. The rotor has laminated core comprising an annular stack of sheets 1 made of ferromagnetic steel, for example electrical steel sheets or other soft magnetic steel sheets. The individual sheets of the sheet stack 1 may be annular sheets or each form only a ring segment. Permanent magnets 2, for example based on Nd2Fe14B, are attached to the inside of the stack 1. The permanent magnets 2 may, for example, be arranged in grooves in the stack 1 and fixed there, for example, by means of adhesive. The stack 1 is inserted into a carrier 3, which has a hub for a shaft.

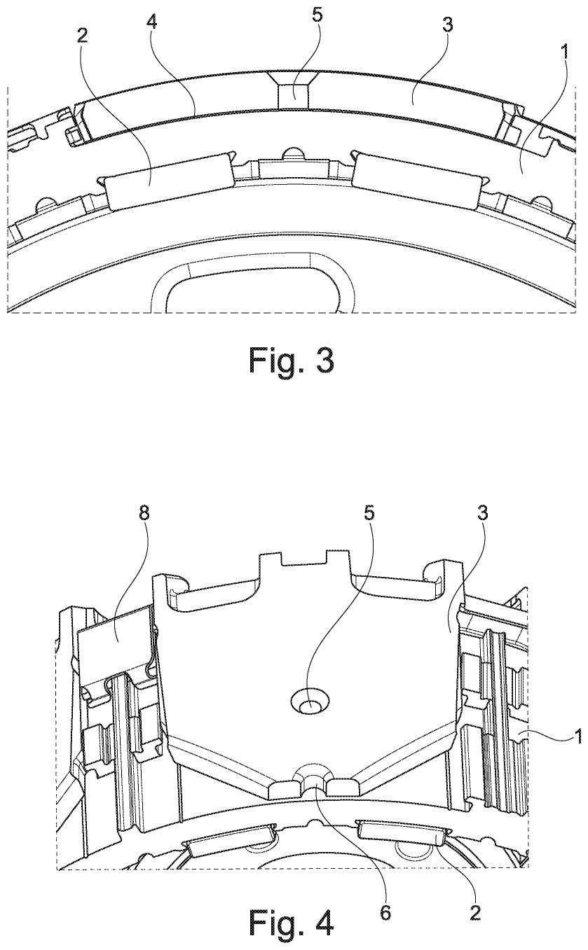

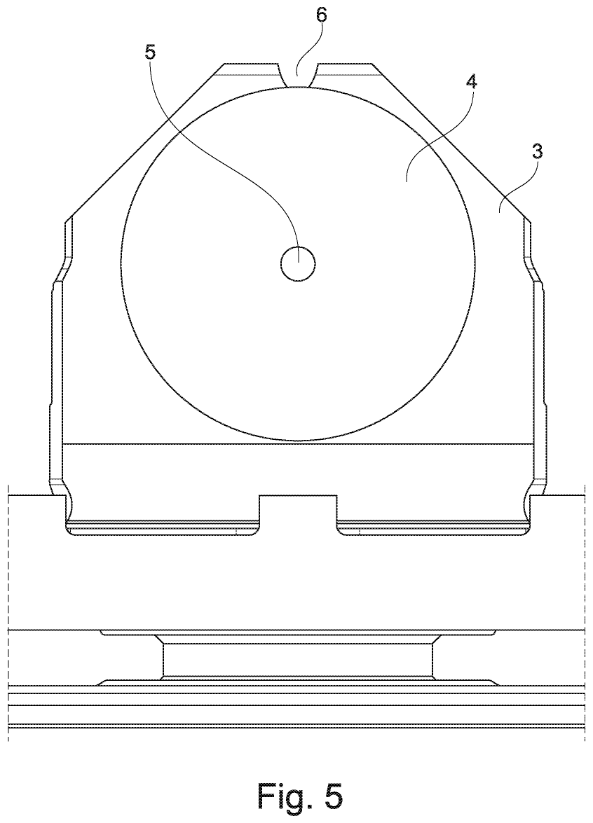

FIG. 3 shows a detail of a sectional view of a rotor, FIG. 4 shows a detail of a view of the rotor from the outside, and FIG. 5 shows a detail of the rotor carrier without sheet stack, viewed from the inside.

In the rotor shown, there is a filling material 4 between an outer side of the stack 1 and an inner side of the carrier 3, which at least partially fills a gap between the stack 1 and the carrier 3. The filling material 4, for example adhesive, prevents the carrier 3 from hitting the stack 1 during operation and producing rattling noises. The carrier 3 has filling openings 5 extending in the radial direction for pouring in the filling material 4. To facilitate the pouring of filling material 4, the filling openings 5 may widen towards the outer side of the carrier 3, for example by having a funnel-shaped section, in particular a conical section.

During the manufacture of the rotor, after the stack 1 has been inserted into the carrier 3, filling material 4 is poured through these filling openings 5 into the gap between the stack 1 and the carrier 3. FIG. 5 shows the carrier 3 with a view of its inside without the stack 1, but with the filling material 4 on its inside. The filling material 4 is usually distributed evenly in all directions from the filling opening 5, thus forming an approximately circular disc, as shown in FIG. 5.

The carrier 3 may have a notch 6 in an axial end face, which runs from an inner side to an outer side of the carrier 3. As soon as filling material 4 is visible in this notch 6, the pouring of filling material 4 through the filling opening 5 closest to the notch 6 can be stopped. In the area of notch 6, the distance between the edge of carrier 3 and filling opening 5 is minimal, so that filling material 4 usually first emerges from the gap between sheet stack 1 and carrier 3 in the area of notch 6, thus preventing filling material 4 from escaping at other points by stopping the filling process.

In the embodiment shown, the carrier 3 has several filling openings 5, for example six to eight filling openings 5, which are evenly distributed in the circumferential direction. Each of these filling openings 5 can be assigned a notch 6 in an axial end face of the carrier 3. If there are several filling openings 5, each of which is assigned a notch 6, the pouring of filling material 4 can be stopped at all filling openings 5 as soon as filling material 4 is visible in any notch 6. However, better results can be achieved if, when filling material 4 enters a notch 6, only the pouring through the nearest filling opening 5 is stopped. In this way, the filling quantity can be adjusted in the circumferential direction to an uneven gap width.

The edge of the carrier 3 has its smallest distance from the nearest filling opening 5 in the notch 6. In the embodiment shown, the depth of the notch 6 and its width measured in the circumferential direction do not exceed twice the width of the filling opening 5.

If adhesive is used as the filling material, no additional means of fastening the carrier to the sheet stack are required. To increase the mechanical load capacity, in the embodiment shown, the sheet metal stack 1 is fastened to the carrier 3 with clamps 8. The clamps 8 grip around a radially outer edge of the carrier 3 and press the carrier 3 in the axial direction against the sheet metal stack 1.

The sheet stack 1 has radial projections 9 between its axial ends on its outer side, which form pressure surfaces against which one end of the clamps 8 presses. The clamps 8 thus grip around the relevant projection 9, on whose pressure surface they act.

In the embodiment shown, the stack 1 is constructed from steel sheets that are identical within their manufacturing tolerances. These ring-shaped steel sheets each have equidistantly arranged projections on their outer circumference, for example 4 to 10 projections.

To assemble the stack 1, the steel sheets are stacked on top of each other in groups, with the sheets within a group lying on top of each other in the same rotational angle position and adjacent groups rotated relative to each other by a rotational angle, in the example shown by 45°. The projections 9 of the adjacent groups are thus offset relative to each other so that the contact surfaces at the boundary between a first and a second group are accessible for the clamps 8. A group can consist of, for example, 4 to 25 sheets.

To assemble the rotor, the sheet stack 1 is inserted into the carrier 3. The carrier has slots running in the axial direction, in which the projections 9 of the sheet stack 1 are arranged. To facilitate the insertion of the sheet stack 1 into the carrier 3, the slots may widen towards their distal end. In the embodiment shown, the slots have a funnel-shaped end section. As FIG. 5 shows, this reduces the area of the gap between the carrier 3 and the sheet stack 1; in particular, it greatly reduces the area of the gap that is not filled with filling material 4.

### LIST OF REFERENCE SIGNS

1 Stack
2 Permanent magnets
3 Carrier
4 Filling material
5 Filling opening
6 Notch
8 Clamps
9 Protrusions

While this invention has been described as having an exemplary design, the present invention may be further modified within the spirit and scope of this disclosure. This application is therefore intended to cover any variations, uses, or adaptations of the invention using its general principles.

What is claimed is:

1. A rotor for an external rotor motor, comprising:
an annular stack of steel sheets welded together,
permanent magnets attached to an inner side of the stack, and
a carrier in which the stack is inserted,
wherein a gap between an outer surface of the stack and an inner surface of the carrier contains a filling material.

2. The rotor according to claim 1, wherein the filling material is adhesive.

3. The rotor according to claim 1, wherein the carrier has a filling opening extending in the radial direction for pouring in filling material.

4. The rotor according to claim 1, wherein the carrier has a notch in an axial end face, which runs from an inner side to an outer side of the carrier.

5. The rotor according to claim 3, wherein the depth of the notch is not more than twice the width of the filling opening.

6. The rotor according to claim 1, wherein the carrier has slots extending in the axial direction, in which clamps are arranged which press the stack in the axial direction against the carrier.

7. The rotor according to claim 6, wherein the slots are open at one end and widen towards their open end.

8. The rotor according to claim 6, wherein the carrier has a filling opening between adjacent slots for pouring in filling material.

9. A rotor for an external rotor motor, comprising:
an annular stack of steel sheets welded together,
permanent magnets attached to an inner side of the stack, and
a carrier in which the stack is inserted,
wherein a gap between an outer surface of the stack and an inner surface of the carrier contains a filling material, and
the carrier has a filling opening extending in the radial direction for pouring in filling material.

10. A method of manufacturing a rotor for an external rotor motor, comprising the following steps:
producing an annular stack from steel sheets,
welding the steel sheets of the stack together,
inserting the stack into a carrier, and
filling a gap between an outer surface of the stack and an inner surface of the carrier through a filling opening of the carrier with filling material.

11. The method according to claim 10, wherein:
during the pouring of filling material, monitoring whether filling material enters a notch which is arranged in an axial end surface of the carrier and runs from an inside to an outside of the carrier, and
stopping the pouring of filling material through the filling opening closest to the notch as soon as filling material is in the notch.
